(19) United States
(12) Patent Application Publication
(10) Pub. No.: US 2003/0075178 A1
(43) Pub. Date: Apr. 24, 2003

(54) Continuous gas leakage for elimination of ventilator dead space

(76) Inventor: Nelson R. Claure, Miami, FL (US)

Correspondence Address: VENABLE, BAETJER, HOWARD AND CIVILETTI, LLP, P.O. BOX 34385, WASHINGTON, DC, 20043-9998, US

(21) Appl. No.: 10/273,300

(22) Filed: Oct. 18, 2002

Related U.S. Application Data
(60) Provisional application No. 60/329,762, filed on Oct. 18, 2001.

(51) Int. Cl. A62B 7/00

(52) U.S. Cl. 128/204.18; 128/204.23

(57) ABSTRACT

A device is provided for removing waste fluid from a fluid supply and removal system that alternately supplies supply fluid to a user and receives the waste fluid from the user. The supply fluid and the waste fluid flow along a flow path, the supply fluid being supplied to and the waste fluid being received from the user by way of a supply tube. The system has a dead space. The device has a flow passage operatively associated with the supply tube and the dead space and directs the supply fluid and the waste fluid. An exhaust tube exhausts a portion of the waste fluid from the system and has a first end operatively associated with the flow passage. The exhaust tube is attached to the system at a location along the flow path between the user and the dead space.

### CROSS-REFERENCE TO RELATED APPLICATION

This application claims priority to U.S. Provisional Patent Application No. 60/329,762, filed Oct. 18, 2001, the disclosure of which is incorporated herein by reference.

### BACKGROUND OF THE INVENTION

1. Field of the Invention

The invention relates to methods and devices for controlling fluid mixtures. More particularly, embodiments of the invention relate to methods and devices for preventing accumulation of gases that are normally eliminated by respiration, either spontaneous or artificial, at mainstream airflow or pressure sensors used in neonatal ventilators. Even more particularly, embodiments of the invention relate to the elimination of the so called dead space added by mainstream sensors used in neonatal ventilators to synchronize mechanical breaths with spontaneous inspiration and measure ventilation.

2. Background Information

Premature infants of very low birth weight often need mechanical ventilatory support for respiratory failure secondary to pulmonary pathology, instability of central respiratory drive, poor effectiveness of the respiratory pump and relatively large anatomical dead space. During the course of mechanical ventilation, clinicians try to maintain adequate arterial blood gases while minimizing the risk of pulmonary damage.

Recent enhancements of conventional time-cycled pressure-limited neonatal ventilators include synchronization of mechanical breaths with the patient's inspiratory effort, ventilation monitoring, analysis of lung mechanics, and volume targeted ventilation. These enhancements involve the use of mainstream airflow or pressure sensors placed in line between an endotracheal tube (ETT) adapter and a ventilator circuit.

Studies of Synchronized Intermittent Mandatory Ventilation (SIMV) have reported increased size and reduced variability of ventilator delivered tidal volumes in comparison to conventional Intermittent Mandatory Ventilation (IMV) and suggested potential benefits in outcome.

### SUMMARY OF THE INVENTION

Mainstream airflow sensors used in neonatal ventilators to synchronize mechanical breaths with spontaneous inspiration and measure ventilation can increase dead space, i.e. the volume added to the anatomic or artificial airway that does not contribute to gas exchange, and impair CO₂ elimination. The invention provides a device and method for dead space washout using controlled gas leakage.

Particular embodiments of the invention provide a continuous gas leakage at an endotracheal tube (ETT) adapter to washout the airflow sensor and allow synchronization and ventilation monitoring without CO₂ rebreathing in preterm infants.

The significant physiologic effects of instrumental dead space in preterm infants during synchronized ventilation can be safely and effectively prevented by the ETT adapter continuous leakage technique.

Particular embodiments of the invention provide a device for removing waste fluid from a fluid supply and removal system that alternately supplies supply fluid to a user and receives the waste fluid from the user. The supply fluid and the waste fluid flow along a flow path, the supply fluid being supplied to and the waste fluid being received from the user by way of a supply tube. The system has a dead space. The device has a flow passage operatively associated with the supply tube and the dead space that directs the supply fluid and the waste fluid. An exhaust tube exhausts a portion of the waste fluid from the system and has a first end operatively associated with the flow passage. The exhaust tube is attached to the system at a location along the flow path between the user and the dead space.

Other embodiments of the invention include a method of removing waste fluid from a fluid supply and removal system that alternately supplies supply fluid to a user and receives the waste fluid from the user. The supply fluid and the waste fluid flow along a flow path, the supply fluid being supplied to and the waste fluid being received from the user by way of a supply tube. The system has a dead space. The method comprises directing the supply fluid and the waste fluid in a flow passage operatively associated with the supply tube and the dead space and exhausting a portion of the waste fluid from the system through an exhaust tube. The exhaust tube has a first end operatively associated with the flow passage. The exhaust tube is attached to the system at a location along the flow path between the user and the dead space.

### BRIEF DESCRIPTION OF THE DRAWINGS

The invention is explained below in further detail with the aid of exemplary embodiments shown in the drawings, wherein like reference numbers represent like elements and wherein:

FIG. 1 is a schematic representation of an ETT adapter continuous leakage technique and instrumental setup in accordance with exemplary embodiments of the invention;

FIG. 2 is a schematic representation of an embodiment of the invention in which the exhaust tube is attached to the airflow sensor;

FIG. 3a is a single-breath capnogram and V_{T} recordings from an infant during intermittent mandatory ventilation (IMV);

FIG. 3b is a single-breath capnogram and V_{T} recordings from an infant during synchronized intermittent mandatory ventilation (SIMV);

FIG. 3c is a single-breath capnogram and V_{T} recordings from an infant during use of the invention (SIMV+Leak);

FIG. 4a shows airflow and capnogram (delayed by 1.9 seconds) recordings from an infant during SIMV; and

FIG. 4b shows airflow and capnogram (delayed by 1.9 seconds) recordings from an infant during use of the invention (SIMV+Leak).

### DETAILED DESCRIPTION OF PREFERRED EMBODIMENTS

Little is known about the effect of the instrumental dead space on carbon dioxide (CO₂) elimination during SIMV, which may become more important when ventilatory support is weaned and infants have to compensate by increasing their spontaneous ventilation.

The ability of preterm infants to eliminate CO₂ is compromised because of their relative large anatomical respiratory dead space (V_{D}) in relation to their tidal volume (V_{T}). The addition of instrumental dead space further increases their V_{D}/V_{T} ratio and can limit their ability to eliminate CO₂, which may result in a higher arterial CO₂ tension, an increase in their central respiratory drive or lead to an increase in mechanical ventilatory support.

A technique to prevent increased concentrations of CO₂ in the inspired gas due to airflow sensor dead space has been developed. This technique consists of a continuous washout of the sensor with fresh gas to clear the sensor of exhaled CO₂ by means of a continuous gas leakage at the ETT adapter. The purpose of this technique is to enable airflow sensor use and take advantage of the potential benefits of synchronization and ventilation monitoring without inducing CO₂ rebreathing.

A study was conducted to determine the effects of airflow sensor dead space during IMV and SIMV and to evaluate the ETT adapter continuous leakage technique on CO₂ elimination, oxygenation, ventilation and spontaneous respiratory effort in a group of mechanically ventilated preterm infants. It was believed that the ETT adapter continuous leakage technique would allow the use of mainstream airflow sensors without increasing CO₂ rebreathing, concentration of CO₂ in alveolar gas, and spontaneous respiratory effort.

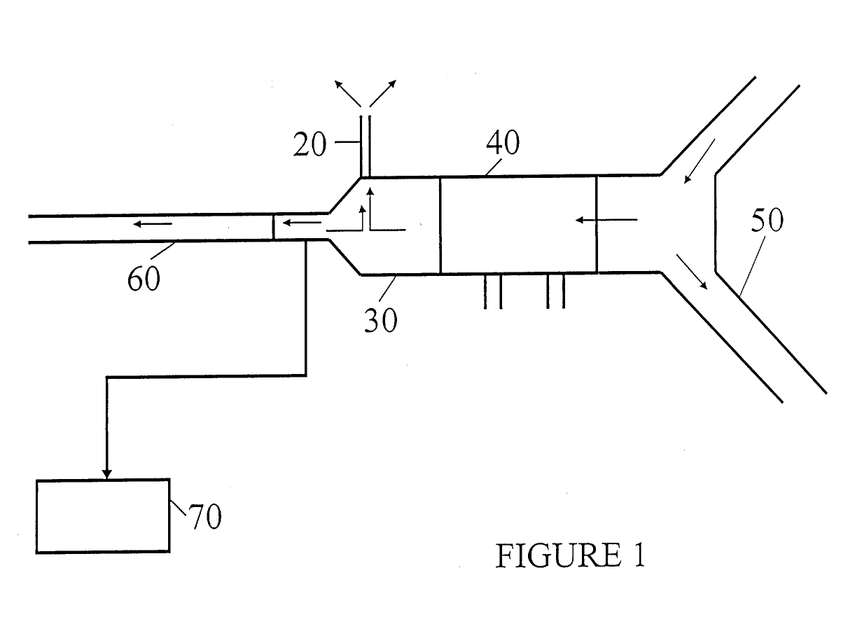

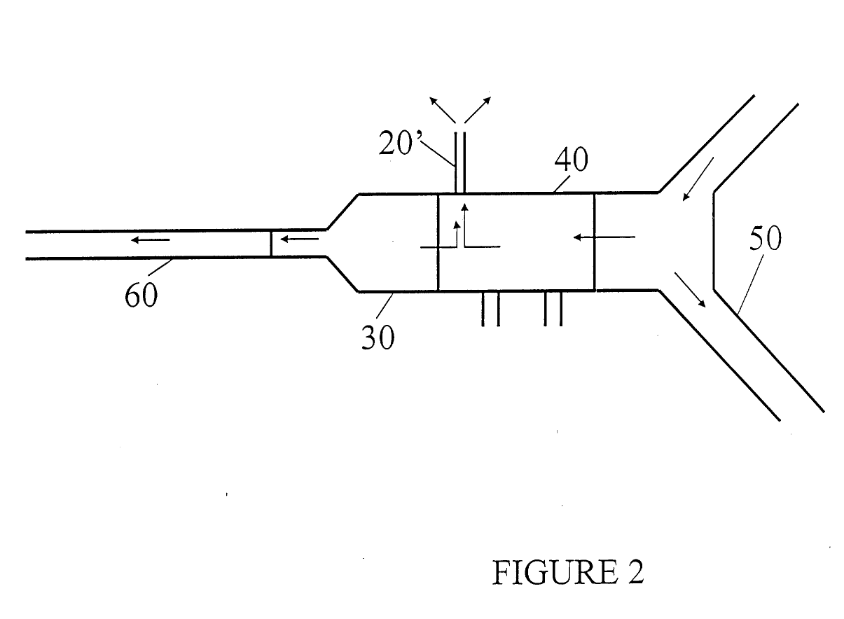

An example of a ventilating system 10 of which the invention can be a part is shown in FIG. 1. In this example, an exhaust tube 20 is attached to an ETT adapter 30 for leaking gas from the flow path of the system. Adapter 30 is placed between an airflow sensor 40 and an endotracheal tube 60. The airflow sensor is, in turn, attached to a ventilator circuit 50. The endotracheal tube is used to intermittently supply supply fluid to the user and channel waste fluid away from the user. While the endotracheal tube is used for both these fluids, it is noted that ideally only one of the fluids will occupy the endotracheal tube at a time. FIG. 1 also shows a microcapnometer 70 attached to adapter 30 for recording particular gas properties. FIG. 2 shows an alternate embodiment of the invention in which exhaust tube 20′ is attached to a housing of airflow sensor 40. Exhaust tube 20, 20′ can be, for example, a 15-millimeter long open-ended tube with a resistance of approximately 680 cm H₂O per liter per second. Leakage flow is continuous during mechanical expiratory time and is determined by the positive end-expiratory pressure (PEEP). Leakage flow increases during mechanical inspiration due to a greater pressure gradient and is highest at peak inspiratory pressure (PIP). In this example, a PEEP of 4 cm H₂O creates a leakage flow of approximately 0.35 liters per minute to clear a volume of 1.1 milliliters in 0.2 seconds. The open-ended tube resistance is sufficiently high to maintain PEEP and allow generation of PIP. An increase in ventilator bias flow may be helpful to generate the desired PIP when mechanical inspiratory time (IT) is short. The leakage flow adds to the flow measured by the sensor and can cause overestimation of the inspiratory flow and underestimation of the exhaled flow. These errors in flow measurement can be minimized or eliminated by various known methods.

Mechanically ventilated preterm infants weighing less than 1500 grams at birth were eligible for the study. Infants were studied during four 30-minute periods in random sequence: IMV (without airflow sensor), IMV+Sensor, SIMV (with airflow sensor), and SIMV+Leak (with ETT adapter continuous leak).

Airway secretions were removed by prior endotracheal suctioning. Infants were studied in their incubators and were left undisturbed.

Ventilatory support was provided by two flow-synchronized time-cycled pressure-limited infant ventilators assigned at random (Babylog 8000, Draeger A G, Lubeck, Germany or VIP Bird, Bird Products Corporation, Palm Springs, Calif.). The Babylog 8000 sensor, a hot wire anemometer, and the VIP Bird sensor, a variable orifice pneumotachograph, have 1.1 and 1.2 milliliters internal volume, respectively. Ventilator settings of PIP, PEEP, IT and rate remained unchanged. Ventilator trigger sensitivity was set at maximum during SIMV and it was lowered to prevent auto-cycling during SIMV+Leak.

Non-invasive measurements of V_{T} and respiratory rate (RR) were obtained by respiratory inductance plethysmography (Respitrace Plus, Sensormedics Corporation, Yorba Linda, Calif.) with two transducer bands wrapped around the rib cage and abdomen at the level of the nipples and umbilicus, respectively. Their relative volumetric expansion was determined by qualitative diagnostic calibration. Minute ventilation (V′_{E}) was calculated as the product of V_{T} and RR.

Airflow measurements were obtained from the VIP Bird's pneumotachograph connected to a differential pressure transducer (Validyne Engineering, Northridge, Calif.) powered by a transducer amplifier (Gould Instrument Systems, Valley View, Ohio) or from the analog output of the Babylog 8000 during IMV+Sensor, SIMV and SIMV+Leak periods.

End-inspiratory and end-expiratory CO₂ concentration was measured by a side-stream capnograph (Micro-capnometer, Columbus Instruments, Columbus, Ohio). Gases were sampled at 5 milliliters per minute through an orifice at the tip of the ETT adapter (FIG. 1). Device accuracy is ±1.0%. It detects up to 130 breaths per minute with 70 milliseconds response time (10_{T}-90_{T}%).

Transcutaneous O₂ (TcPO₂) and CO₂ tension (TcPCO₂) were measured by a heated transcutaneous electrode (Transcend Shuttle or Microgas 7560, Sensormedics Corporation, Yorba Linda, Calif.). Arterial oxygen saturation (SpO₂) was measured by pulse oximetry (Radical, Masimo Corporation, Calif. or Oxypleth 520 A, Novametrix Medical Systems, Wallingford, Conn.). Fraction of inspired oxygen (FiO₂) was measured by an oxygen analyzer (O2000, Maxtec, Utah).

All signals were digitized at 100 Hz and recorded in a personal computer (AT-CODAS, Dataq Instruments, Akron, Ohio).

The first half of each 30-minute recording period was considered an adjustment interval. The following parameters were calculated over the last 15 minutes of each 30 minute recording period: Mean TcPCO₂, TcPO₂, FiO₂ and SpO₂. Average end-inspiratory CO₂ concentration was obtained from the first five breaths of each minute. Average end-expiratory CO₂ concentration was obtained from the first five breaths of each minute with end-expiratory plateau.

Average V_{T}, V′_{E}, and RR measured by inductance plethysmography is reported in arbitrary units (AU), AU per minute and breaths per minute, respectively.

Statistical analysis was done by repeated measures analysis of variance (RM ANOVA). The Student-Newman-Keuls method was used for pair wise comparisons. A p value less than 0.05 was considered significant. Data are reported as mean±standard deviation.

Ten preterm infants undergoing mechanical ventilation were studied. All infants tolerated well all four periods and there were no adverse events. Their birth weight was 835±244 grams and gestational age was 26±2 weeks. They were studied at 19±9 days of age (28.6±1.7 weeks post-conceptional age). Their ventilatory support consisted of a mechanical rate of 21±6 breaths per minute, PIP of 16±1 cm H₂O, PEEP of 4.2±0.4 cm H₂O and required a FiO₂ of 0.26±0.6 to maintain SpO₂ above 90%. IT ranged between 0.35 and 0.4 seconds and ventilator bias flow between 8 and 9 liters per minute. Eight infants were ventilated though a 2.5-millimeter and two infants through a 3.0-millimeter internal diameter uncuffed ETT. ETT length ranged between 10 and 12 centimeters. No infant had gas leakage around the distal end of the ETT during Tₑ.

The instrumental dead space added by the flow sensor increased CO₂ rebreathing. End-inspiratory CO₂ concentration was significantly higher with the airflow sensor in place during the IMV+Sensor and SIMV periods. The ETT adapter continuous leakage cleared most of the exhaled CO₂ from the airflow sensor during the SIMV+Leak period and end-inspiratory CO₂ concentration remained within the range observed during the IMV period without airflow sensor in place. (See Table 1).

TABLE 1

| | IMV | IMV + Sensor | SIMV | SIMV + Leak |
|---|---|---|---|---|
| End-Insp. CO₂ [%] | 0.12 ± 0.11 | 0.73 ± 0.38* | 0.75 ± 0.39* | 0.18 ± 0.20 |
| End-Exp. CO₂ [%] | 5.88 ± 1.08 | 6.79 ± 1.25* | 6.63 ± 1.36* | 5.87 ± 1.15 |
| TcPCO₂ [mmHg] | 60.1 ± 13.3 | 64.5 ± 11.9† | 64.4 ± 13.3† | 59.4 ± 11.9 |
| V'_{E}[AU per minute] | 595 ± 86 | 878 ± 228* | 823 ± 187* | 620 ± 120 |
| V_{T}[AU] | 13.0 ± 1.9 | 16.5 ± 4.7† | 15.9 ± 4.2† | 13.4 ± 3.2 |
| RR [breaths per minute] | 47.6 ± 8.9 | 54.2 ± 8.2 | 52.6 ± 7.8 | 47.6 ± 7.4 |

*p < 0.01 versus IMV and SIMV + Leak.
†p < 0.05 versus IMV and SIMV + Leak.
AU Arbitrary units.

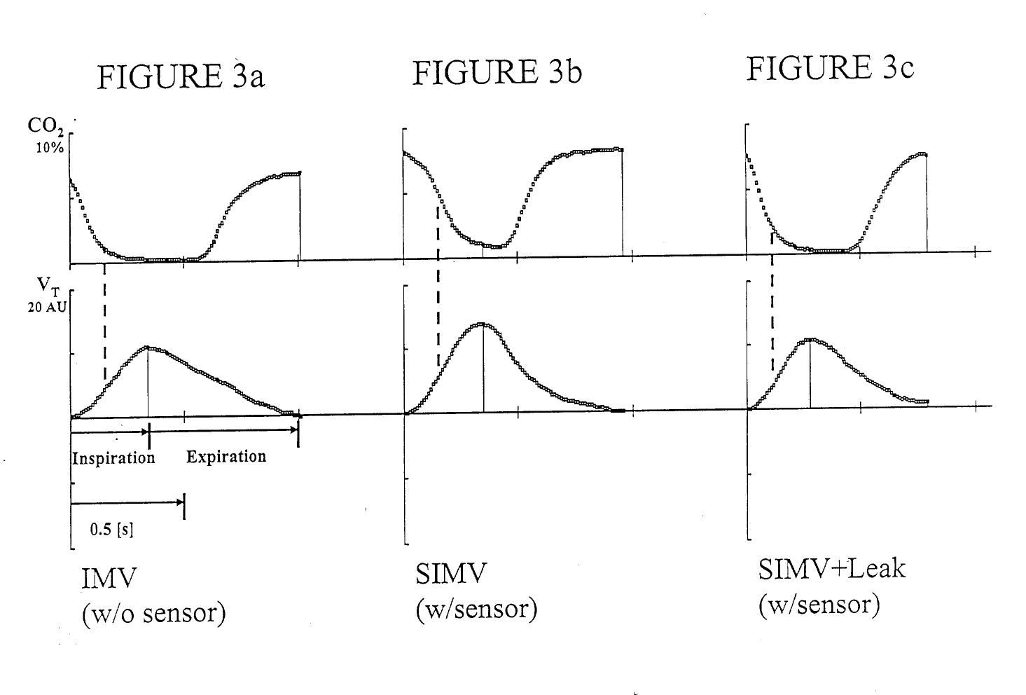

The additional dead space also lowered the rate of change in CO₂ concentration during the early phase of inspiration. Compared to FIG. 3a, the capnogram of FIG. 3b shows a slower decrease in CO₂ during early inspiration with the airflow sensor in place, resulting in a higher concentration of CO₂ being inhaled at a similar inspiratory volume during the first half of inspiration. The fast clearance of exhaled CO₂ from the airflow sensor by the ETT adapter continuous leakage almost completely eliminates such effect as shown in FIG. 3c.

CO₂ concentration in alveolar gas also increased with the airflow sensor in place. End-expiratory CO₂ concentration was significantly higher during IMV+Sensor and SIMV compared to IMV and SIMV+Leak periods and correlated with a significant rise in TcPCO₂. End-expiratory CO₂ concentration and TcPCO₂ measurements during SIMV+Leak were similar to those observed during IMV (See Table 1).

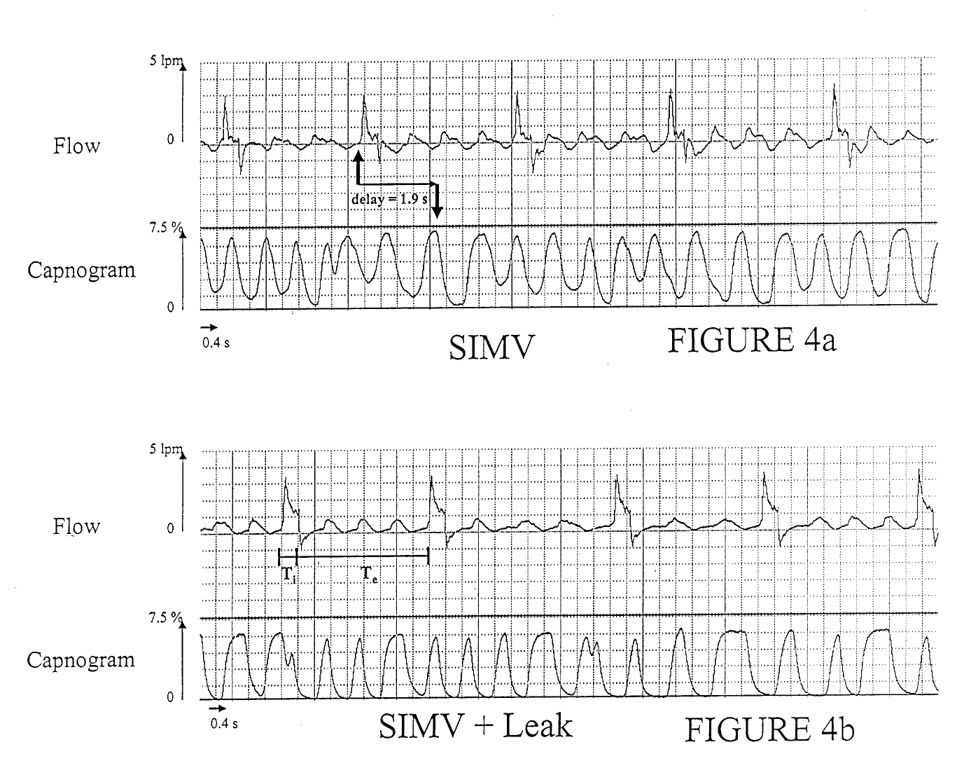

Simultaneous airflow and capnographic recordings from an individual infant shown in FIG. 4a illustrate the increase in end-inspiratory and end-expiratory CO₂, as well as the slower rate of CO₂ concentration change in inhaled gas during SIMV. During SIMV+Leak (FIG. 4b), the ETT adapter continuous leakage lowered end-inspiratory and end-expiratory CO₂ and resulted in a faster CO₂ concentration drop during inspiration. The leakage flow produced a constant inspiratory offset in the measured airflow signal during mechanical expiration which increased during inspiration.

Since ventilator settings remained constant, the reduced ability to eliminate CO₂ due to airflow sensor dead space led to an increase in compensatory spontaneous respiratory effort, resulting in a significantly higher spontaneous V′_{E} during IMV+Sensor and SIMV periods. The significant increase in V′_{E} resulted from a significantly larger V_{T} and a slight but not consistent rise in RR. This increase in V′_{E} was not observed during the SIMV+Leak period, with V_{T} and RR remaining within the ranges observed during IMV (See Table 1), correlating with the relatively unchanged CO₂ levels during SIMV+Leak compared to IMV.

ETT adapter continuous leakage during SIMV+Leak did not impair oxygenation, which was relatively constant during the entire study. While average levels of SpO₂ and FiO₂ remained unchanged, there was a small but not consistent rise in TcPO₂ during IMV+Sensor and SIMV.

PEEP remained unaffected by the ETT adapter continuous leak, while ventilator bias flow was increased slightly to generate the set PIP when IT was 0.35 seconds. Ventilator trigger threshold was adjusted at initiation of the SIMV+Leak period and no auto-cycling was observed. Ventilator measurements underestimated exhaled flow, V_{T} and V′_{E} in the presence of the ETT adapter continuous leakage. No differences in CO₂ rebreathing, TcPCO₂ and V′_{E} were observed between infants grouped by ventilator model.

Little is known about the effect of instrumental dead space on gas exchange in preterm infants undergoing synchronized mechanical ventilation. In this group of infants, instrumental dead space increased CO₂ rebreathing and resulted in a significantly higher alveolar CO₂ and TcPCO₂, and led to an increase in spontaneous compensatory respiratory effort. These effects should not be particular to the ventilators used in this study and most likely apply to any device equipped with mainstream sensors.

The unwanted physiologic effects were safely and effectively prevented by the ETT adapter continuous leakage technique, suggesting its application for elimination of the instrumental dead space in other ventilatory modalities and ventilation monitoring devices that require mainstream sensors.

The effectiveness of the ETT adapter continuous leakage was increased by the fast clearance of exhaled gas at end-expiration when concentration of CO₂ is highest. This end-expiratory gas is mixed with fresh gas and is partially inhaled during the early phase of the following inspiration when a mainstream sensor is in place, as illustrated in FIG. 3b.

In spite of a relatively small internal volume of the flow sensors used in this study and of inspiratory tidal volumes that exceeded it, there was some concentration of CO₂ detected at end-inspiration. This phenomenon could be explained by the presence of pockets of CO₂ due to preferential streams of fresh gas or low turbulence during inspiration.

Direct connection of the ETT adapter to the ventilator circuit resulted in a negligible concentration of CO₂ at end-inspiration during IMV. However, removal of the airflow sensor eliminates the potential benefits of synchronized ventilation and disables V_{T} monitoring, which is particularly important in preterm infants at risk of lung injury from volutrauma.

Risks involved in the use of the ETT adapter continuous leakage technique are relatively low. In this study, ventilator auto-cycling was prevented by trigger threshold adjustment. To facilitate proper ventilation measurement, simple real time correction algorithms could be implemented since the physical characteristics of the continuous leakage are known and stay relatively constant. Patency of the open-ended tubing is maintained against occlusion by secretions or other fluids by the PIP. If occlusion would occur, it will revert the setup to the conventional configuration.

A condition that facilitates CO₂ clearance is gas leakage around an uncuffed ETT. This is often observed in premature infants and is more frequent among infants who remain intubated for prolonged periods of time. This spontaneously occurring gas leakage can have similar effects to those obtained by the ETT adapter continuous leakage technique. However, it is uncontrolled since its magnitude varies depending on the infants' position and location of the distal-end of the ETT.

A very important finding is the rise in TcPCO₂ when the flow sensor was in place, suggesting that in spite of a significant increase in their spontaneous respiratory effort, these infants were not able to fully compensate for the increased dead space. In this situation, a delayed weaning or a further increase in mechanical ventilatory support to prevent hypercapnia may increase the risk of lung baro- and volutrauma, counterbalancing the potential benefits of SIMV.

While the ETT adapter continuous leakage produced a significant reduction in CO₂ rebreathing, TcPCO₂ and spontaneous respiratory effort during synchronized mechanical ventilation, an additional, important clinical consequence may result from the more efficient spontaneous ventilation, allowing a reduction in mechanical support.

While the invention is described using examples having open-ended exhaust tubes, other embodiments can use a fluid pump attached to the end of the exhaust tube to continuously control the fluid flow within the exhaust tube. In addition, while the invention is described using examples that supply gases, it is noted that the invention can also be applied to liquid supplying system.

The invention has been described in detail with respect to preferred embodiments and it will now be apparent from the foregoing to those skilled in the art that changes and modifications may be made without departing from the invention in its broader aspects. The invention, therefore, is intended to cover all such changes and modifications that fall within the true spirit of the invention.

I claim:

1. A device for removing waste fluid from a fluid supply and removal system that alternately supplies supply fluid to a user and receives the waste fluid from the user, the supply fluid and the waste fluid flowing along a flow path, the supply fluid being supplied to and the waste fluid being received from the user by way of a supply tube, the system having a dead space, the device comprising:
a flow passage operatively associated with the supply tube and the dead space and for directing the supply fluid and the waste fluid; and
an exhaust tube for exhausting a portion of the waste fluid from the system, the exhaust tube having a first end operatively associated with the flow passage,
wherein the exhaust tube is attached to the system at a location along the flow path between the user and the dead space.

2. The device of claim 1, wherein a second end of the exhaust tube is open.

3. The device of claim 1, wherein the first end of the exhaust tube is attached to the flow passage.

4. The device of claim 1, further comprising an airflow sensor.

5. The device of claim 4, wherein the first end of the exhaust tube is attached to a housing of the airflow sensor.

6. The device of claim 1, wherein the fluid supply and removal system is a neonatal ventilator.

7. The device of claim 6, wherein the flow passage is an endotracheal tube.

8. The device of claim 7, wherein the waste fluid comprises CO₂.

9. The device of claim 1, wherein the supply fluid and the waste fluid are gases.

10. The device of claim 1, wherein a portion of the supply fluid exits the system through the exhaust tube while the supply fluid is being supplied to the user.

11. A method of removing waste fluid from a fluid supply and removal system that alternately supplies supply fluid to a user and receives the waste fluid from the user, the supply fluid and the waste fluid flowing along a flow path, the supply fluid being supplied to and the waste fluid being received from the user by way of a supply tube, the system having a dead space, the method comprising:
directing the supply fluid and the waste fluid in a flow passage operatively associated with the supply tube and the dead space; and
exhausting a portion of the waste fluid from the system through an exhaust tube, the exhaust tube having a first end operatively associated with the flow passage,
wherein the exhaust tube is attached to the system at a location along the flow path between the user and the dead space.

12. The method of claim 11, wherein a second end of the exhaust tube is open.

13. The method of claim 11, wherein the first end of the exhaust tube is attached to the flow passage.

14. The method of claim 11, wherein the system further comprises an airflow sensor.

15. The method of claim 14, wherein the first end of the exhaust tube is attached to a housing of the airflow sensor.

16. The method of claim 11, wherein the fluid supply and removal system is a neonatal ventilator.

17. The method of claim 16, wherein the flow passage is an endotracheal tube.

18. The method of claim 17, wherein the waste fluid comprises CO₂.

19. The method of claim 11, wherein the supply fluid and the waste fluid are gases.

20. The method of claim 11, wherein a portion of the supply fluid exits the system through the exhaust tube while the supply fluid is being supplied to the user.
